(19) United States
(12) Patent Application Publication
(10) Pub. No.: US 2024/0208651 A1
(43) Pub. Date: Jun. 27, 2024

(54) SERVICE TROLLEY WITH BALL CASTER ASSEMBLY

(71) Applicants: Safran Cabin Catering B.V., Akmaar (NL); Safran Cabin, Inc., Huntington Beach, CA (US)

(72) Inventors: Adriaan Eijkelenboom, Alkmaar (NL); Mike Romero, Huntington Beach, CA (US)

(21) Appl. No.: 18/087,656

(22) Filed: Dec. 22, 2022

(51) Int. Cl. B64D 11/00; B60B 33/00; B60B 33/08

(52) U.S. Cl. CPC B64D 11/0007; B60B 33/0078; B60B 33/08

(57) ABSTRACT

Described are service trolleys with ball caster assemblies for a passenger vehicle. The service trolley may include a housing and a set of ball caster assemblies. The housing may include an internal component, a top end, and a bottom end. The set of ball caster assemblies may be positioned on the bottom end. Each ball caster assembly may include a caster housing and a sphere wheel that is retained within the caster housing.

### FIELD OF THE INVENTION

The field of the invention relates to service trolleys for passenger vehicles, and, more particularly, to a service trolley with ball caster assemblies for passenger vehicles.

### BACKGROUND

Passenger vehicles, such as airplanes, automobiles, and the like often facilitate various services to passengers using the passenger vehicles. The services can involve a service trolley, which may transports various goods for passengers. The service trolley may be rolled across a floor of a passenger vehicle, but it may be difficult to navigate the service trolley and in some instances the trolley becomes trapped within its stowage envelope. For example, wheels of the service trolley consists of a castor assembly. Castors need to cover a small roll out distance to orient and align themselves in the target direction. In the case of four castors located at each corner of the rectangular base. In some instances, some or all castors are oriented in direction other than the intended direction. This instance requires the trolley to be pushed and pulled multiple times to align the castors. In certain occasion, when the trolley is in its storage envelope, a “wiggling” or side to side forces while pulling or pushing the trolley is necessary to remove it from its stowage. In other instance, navigating the trolley through a narrow aisle or corridor may not effectively traverse the floor of the passenger vehicle, may get caught on floor tracks or passenger seats, and the like.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a service trolley may be used onboard passenger transportation vehicles. The service trolley may include a housing and a set of ball caster assemblies. The housing may include an internal compartment, a top end, and a bottom end. The set of ball caster assemblies may be positioned on the bottom end of the housing. Each ball caster assembly may include a caster housing and a sphere wheel retained within the caster housing of the ball caster assembly.

In some embodiments, the set of ball caster assemblies may include four ball caster assemblies.

In certain embodiments, each ball caster assembly may additionally include a collar attached to a bottom end of the caster housing of the ball caster assembly, and the collar may retain the sphere wheel within the caster housing of the ball caster assembly.

In some embodiments, each ball caster assembly may additionally include a bearing housing and a bearing within the caster housing. The bearing may be positioned on top of the sphere wheel within the caster housing.

In certain embodiments, at least one ball caster assembly of the set of ball caster assemblies may additionally include a braking system.

In some embodiments, the braking system may include a static brake pad within the caster housing and a dynamic brake pad configured to selectively clamp the sphere wheel.

In certain embodiments, the braking system may additionally include a pedal connected to the dynamic brake pad using a wire, rod, chain, or other suitable device or mechanism.

In some embodiments, at least one ball caster assembly of the set of ball caster assemblies may include a driven sphere wheel.

In certain embodiments, at least one ball caster assembly of the set of ball caster assemblies may include a freely rotating sphere wheel.

In some embodiments, the caster housing of at least one ball caster assembly may include at least two fingers and a window between the at least two fingers.

In some embodiments, the at least two fingers may be configured to independently deflect outwards.

In various embodiments, a first finger of the at least two fingers may include a first length, and a second finger of the at least two fingers may include a second length that is less than the first length.

In various embodiments, the second finger may be arranged facing an aft direction of the trolley or a forward direction of the trolley.

In certain embodiments, the at least two fingers may include at least three fingers, and a lower portion of two of the at least three fingers may be connected.

In some embodiments, the service trolley may additionally include a braking wedge within the housing and configured to selectively engage the sphere wheel.

According to certain embodiments of the present invention, a ball caster assembly may be used for a service trolley onboard passenger transportation vehicles. The ball caster assembly may include a housing and a sphere ball. The housing may include a set of fingers that define a receiving area. The set of fingers may include non-uniform lengths. The sphere ball may be retained within the receiving area of the housing.

In some embodiments, at least one finger of the set of fingers may be configured to selectively deflect outwards.

In certain embodiments, the ball caster assembly may additionally include a braking wedge within the receiving area and configured to selectively engage the sphere ball.

According to certain embodiments of the present invention, a service trolley may be used onboard passenger transportation vehicles. The service trolley may include a housing and a ball caster assembly. The housing may include an internal compartment, a top end, and a bottom end. The ball caster assembly may be positioned on the bottom end of the housing and may include a caster housing and a sphere ball. The caster housing may include a set of fingers that may define a receiving area. At least one finger of the set of fingers may be configured to selectively deflect outwards, and the sphere ball may be selectively retained within the receiving area.

In some embodiments, at least one finger of the plurality of fingers may include a length that is less than a length of another finger of the set of fingers.

### BRIEF DESCRIPTION OF THE DRAWINGS

FIG. 1 is a perspective view of a service trolley with ball caster assemblies, according to certain embodiments of the present invention.

FIG. 2 is a sectional side-view of a ball caster assembly of the service trolley of FIG. 1.

FIG. 3 is a perspective view of a ball caster assembly with a set of fingers, according to certain embodiments of the present invention.

FIG. 4 is a set of side-views of the ball caster assembly of FIG. 3.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The described embodiments of the invention provide service trolleys with ball caster assemblies for a passenger vehicle. While the service trolleys with ball caster assemblies are discussed for use with the passenger vehicle, they are by no means so limited. Rather, embodiments of the service trolleys with ball caster assemblies may be used in passenger vehicles of any type or otherwise as desired.

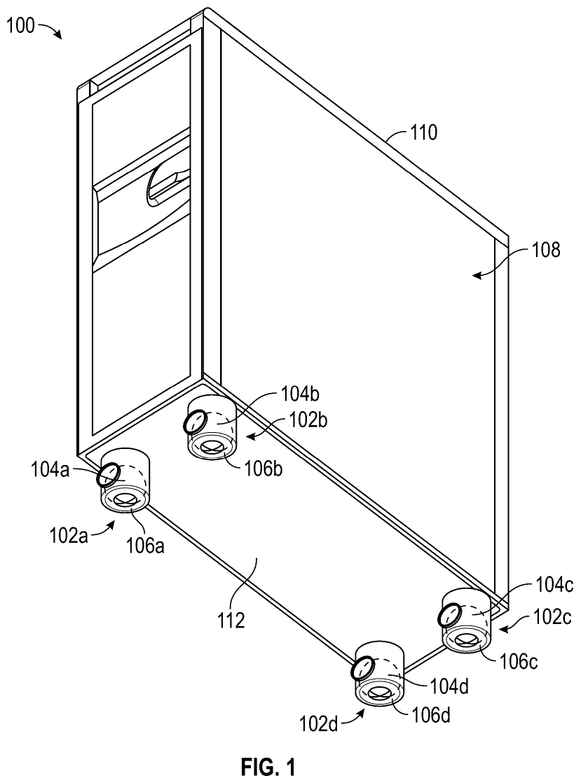

FIG. 1 is a perspective view of a service trolley 100 with ball caster assemblies 102a-d, according to certain embodiments of the present invention. The service trolley 100 may be used on passenger vehicles, such as airplanes, trains, and the like, or at other suitable venues. In some embodiments, the service trolley 100 may be configured to carry items, such as drinks or other products, to entities, such as passengers, via rolling on a floor of the passenger vehicles, etc. The ball caster assemblies 102a-d may facilitate the movement of the service trolley 100 via sphere wheels 104a-d that are illustrated as positioned in housings 106a-d. Additionally, the service trolley 100 may include a housing 108 that includes a top end 110 and a bottom end 112. The ball caster assemblies 102a-d may be positioned on the bottom end 112 of the housing 108. Compared to traditional service trolleys that utilize wheels, the ball caster assemblies 102a-d may allow for improved movement and positioning of the service trolley 100 onboard a passenger vehicle. As a non-limiting example, while wheels may require particular alignment for stowage and/or movement in various directions, the ball caster assemblies 102a-d maintain a proper orientation regardless of movement of the trolley 100.

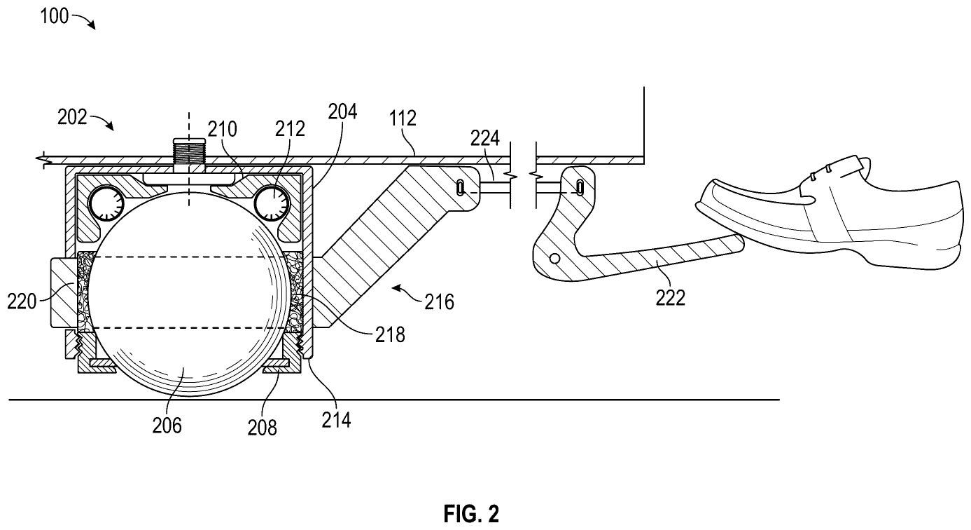

FIGS. 2-4 illustrate another example of a ball caster assembly 202 according to certain embodiments of the present invention. In some embodiments, the ball caster assembly 202 may be optimized for use in passenger vehicles. As non-limiting examples, the ball caster assembly 202 may allow a sufficient ground clearance to allow the service trolley to traverse uneven floors on the passenger vehicles. Additionally, or alternatively, the ball caster assembly 202 may allow for removal of dirt or other debris that may be caught during use of the trolley and may seize the sphere wheel and increase a difficulty of moving the service trolley 100.

As best shown in FIGS. 2-4, a ball caster assembly 202 includes a caster housing 204 and a sphere wheel 206 that may be retained in the caster housing 204. In some embodiments, a set of ball caster assemblies may be positioned on the bottom end 112 of the housing 108 of the service trolley 100. The service trolley 100 may include four ball caster assemblies 202, though other suitable numbers (e.g., less than four or more than four) of ball caster assemblies 202 are possible for the service trolley 100.

As best illustrated with respect to FIG. 2, the ball caster assembly 202 may additionally include a collar 208, a bearing housing 210, and a bearing 212. The collar may be attached to a bottom end 214 of the caster housing 204 of the ball caster assembly 202. The collar 208 may retain the sphere wheel 206 within the caster housing 204 of the ball caster assembly 202. The bearing housing 210 and the bearing 212 may be positioned in the caster housing 204, and the bearing may be positioned on top of the sphere wheel 206. In some embodiments, the ball caster assembly 202 may include a driven sphere wheel. The driven sphere wheel may be driven by a motor, such as an electric motor, that may be controlled by a computing device, an entity controlling the service trolley 100, or the like. In other examples, the ball caster assembly 202 may include a freely rotating sphere wheel. The freely rotating sphere wheel may freely rotate in response to the service trolley 100 moving with respect to floor of the passenger vehicle, or the like.

As best illustrated with respect to FIG. 2, the ball caster assembly 202 optionally may include a braking system 216. In some embodiments one, two, three, or all of the ball caster assemblies of the service trolley 100 may include the braking system 216. The braking system 216 may be various types of braking systems as desired. As a non-limiting example, the braking system 216 may include a static brake pad 218 positioned in the caster housing 204 and a dynamic brake pad 220 that may be configured to selectively clamp the sphere wheel 206. Additionally, the braking system 216 may include a pedal 222 connected to the dynamic brake pad 220 using a wire 224, rod, chain, or other suitable device or mechanism as desired.

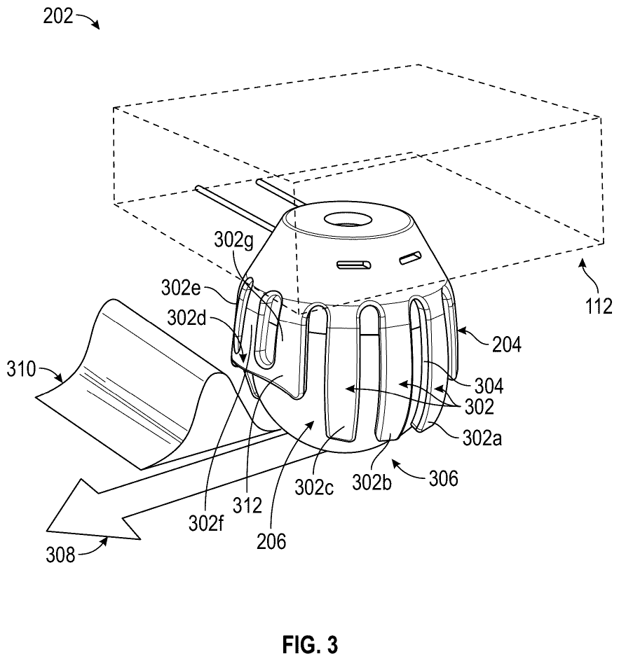

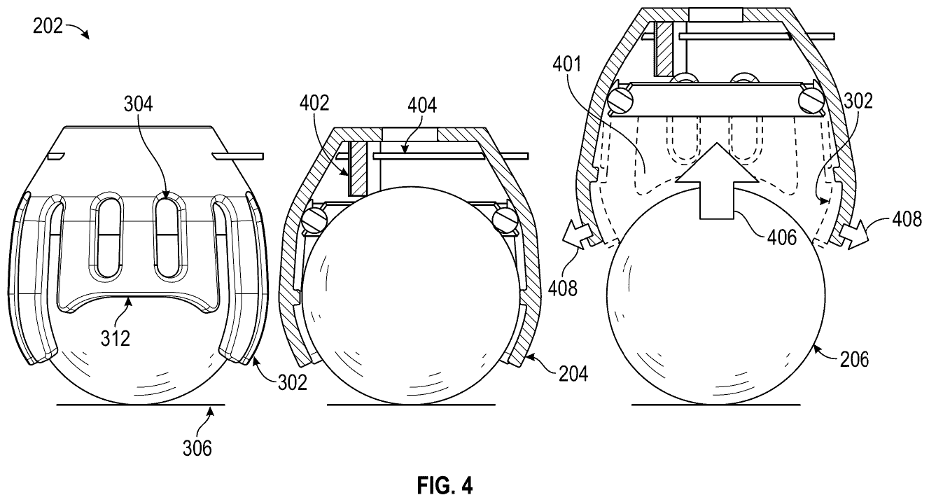

As best illustrated with respect to FIGS. 3-4, in certain embodiments, the caster housing 204 of the ball caster assembly 202 may include at least two fingers 302a-b and a window 304 between the at least two fingers 302a-b. The window 304 can be present between fingers 302a-g to facilitate cleaning debris collected within housing 204. In some embodiments, the at least two fingers 302a-b may be configured to independently deflect outwards, for example with respect to the sphere wheel 206. A first finger 302b may have a first length, and a second finger 302c may have a second length that is less than the first length. In some embodiments, the first length may be similar or equal to the second length.

As best illustrated with respect to FIG. 3, the fingers 302 may be arranged in a direction optimal for traversing the service trolley 100 along a floor 306 of the passenger vehicle. For example, the finger 302d may be arranged facing a forward direction 308 of the service trolley 100. In other embodiments, the finger 302d may be arranged facing an aft direction of the service trolley 100. The arrangement of the finger 302d, which may have a length similar to or less than the first length and/or the second length, may facilitate traversal of the service trolley 100 along the floor 306 and may allow the service trolley to traverse obstacles such as a bump 310. In some embodiments, each finger may include a set of fingers. For example, the finger 302d may include fingers 302e-g or any other suitable number of fingers for the finger 302d. At least a lower portion of the fingers 302e-g may be connected, for example by connector 312.

As best illustrated with respect to FIG. 4, the sphere wheel 206 may be mechanically pressed into a receiving area 401 of the caster housing 204 of the ball caster assembly 202. The sphere wheel 206 may snap-fit into the caster housing 204 or may otherwise suitably fit into the caster housing 204 to facilitate traversal of the service trolley 100 along the floor 306 of the passenger vehicle, etc. In some embodiments, a braking wedge 402 may be positioned in the caster housing 204, or in other suitable locations such as the housing 108 of the service trolley 100, and may be configured to selectively engage the sphere wheel 206. The braking wedge 402 may be connected to a handle, a pedal, or other component of the service trolley 100 via wire 404 (or rod, chain, other suitable device or mechanism, etc.). Actuating the handle, pedal, or other component of the service trolley 100 may actuate the braking wedge 402 to cause the braking wedge 402 to apply a braking force to the sphere wheel 206. To position the sphere wheel 206 into the caster housing 204, the sphere wheel 206 may be pressed, for example in direction 406, into the fingers 302, and the fingers 302 may deflect outward, for example in direction 408, to allow the sphere wheel 206 to be positioned in the caster housing 204.

Additionally, the service trolley 100, or any component thereof, may include various metals or metallic elements as desired, including but not limited to aluminum, an aluminum alloy, titanium, a titanium alloy, nickel, a nickel alloy, brass, a brass alloy, steel, a steel alloys, stainless steel or a stainless steel alloy combinations thereof, or any other suitable metal or metallic alloy. In other non-limiting examples, the service trolley 100, or any component thereof, includes other types of metallic elements, such as titanium, zinc, and the like, or metallic alloys such as titanium alloys, zinc alloys, and the like. In some embodiments, some components (e.g., the caster housing 204, the sphere wheel 206, etc.) may include non-metallic elements such as rubber, polymer, plastics, and the like.

In the following, further examples are described to facilitate the understanding of the invention:

Example 1. A service trolley for use onboard passenger transportation vehicles, the service trolley comprising: a housing comprising an internal compartment, the housing comprising a top end and a bottom end; and a plurality of ball caster assemblies on the bottom end of the housing, wherein each ball caster assembly of the plurality of ball caster assemblies comprises a caster housing and a sphere wheel retained within the caster housing of the ball caster assembly.

Example 2. The service trolley of any of the preceding or subsequent examples, wherein the plurality of ball caster assemblies comprises four ball caster assemblies.

Example 3. The service trolley of any of the preceding or subsequent examples, wherein each ball caster assembly further comprises a collar attached to a bottom end of the caster housing of the ball caster assembly, wherein the collar retains the sphere wheel within the caster housing of the ball caster assembly.

Example 4. The service trolley of any of the preceding or subsequent examples, wherein each ball caster assembly further comprises a bearing housing and a bearing within the caster housing.

Example 5. The service trolley of any of the preceding or subsequent examples, wherein at least one ball caster assembly of the plurality of ball caster assemblies further comprises a braking system.

Example 6. The service trolley of any of the preceding or subsequent examples, wherein the braking system comprises a static brake pad within the caster housing and a dynamic brake pad configured to selectively clamp the sphere wheel.

Example 7. The service trolley of any of the preceding or subsequent examples, wherein the braking system further comprises a pedal connected to the dynamic brake pad using a wire, rod, or chain.

Example 8. The service trolley of any of the preceding or subsequent examples, wherein at least one ball caster assembly of the plurality of ball caster assemblies comprises a driven sphere wheel.

Example 9. The service trolley of any of the preceding or subsequent examples, wherein at least one ball caster assembly of the plurality of ball caster assemblies comprises a freely rotating sphere wheel.

Example 10. The service trolley of any of the preceding or subsequent examples, wherein the caster housing of at least one ball caster assembly comprises at least two fingers and a window between the at least two fingers.

Example 11. The service trolley of any of the preceding or subsequent examples, wherein the at least two fingers are configured to independently deflect outwards.

Example 12. The service trolley of any of the preceding or subsequent examples, wherein a first finger of the at least two fingers comprises a first length, and wherein a second finger of the at least two fingers comprises a second length that is less than the first length.

Example 13. The service trolley of any of the preceding or subsequent examples, wherein the second finger is arranged facing an aft direction of the trolley or a forward direction of the trolley.

Example 14. The service trolley of any of the preceding or subsequent examples, wherein the at least two fingers comprise at least three fingers, and wherein a lower portion of two of the at least three fingers are connected.

Example 15. The service trolley of any of the preceding or subsequent examples, further comprising a braking wedge within the housing and configured to selectively engage the sphere wheel.

Example 16. A ball caster assembly for a service trolley for use onboard passenger transportation vehicles, the ball caster assembly comprising: a housing comprising a plurality of fingers, wherein the plurality of fingers define a receiving area, and wherein the plurality of fingers comprise non-uniform lengths; and a sphere ball retained within the receiving area of the housing.

Example 17. The ball caster assembly of any of the preceding or subsequent examples, wherein at least one finger of the plurality of fingers is configured to selectively deflect outwards.

Example 18. The ball caster assembly of any of the preceding or subsequent examples, further comprising a braking wedge within the receiving area and configured to selectively engage the sphere ball.

Example 19. A service trolley for use onboard passenger transportation vehicles, the service trolley comprising: a housing comprising an internal compartment, the housing comprising a top end and a bottom end; and a ball caster assembly on the bottom end of the housing, the ball caster assembly comprising a caster housing and a sphere ball, wherein the caster housing comprises a plurality of fingers defining a receiving area, wherein at least one finger of the plurality of fingers is configured to selectively deflect outwards, and wherein the sphere ball is selectively retained within the receiving area.

Example 20. The service trolley of any of the preceding or subsequent examples, wherein at least one finger of the plurality of fingers comprises a length that is less than a length of another finger of the plurality of fingers.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the FIG. (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

That which is claimed is:

1. A service trolley for use onboard passenger transportation vehicles, the service trolley comprising:
a housing comprising an internal compartment, the housing comprising a top end and a bottom end; and
a plurality of ball caster assemblies on the bottom end of the housing, wherein each ball caster assembly of the plurality of ball caster assemblies comprises a caster housing and a sphere wheel retained within the caster housing of the ball caster assembly.

2. The service trolley of claim 1, wherein the plurality of ball caster assemblies comprises four ball caster assemblies.

3. The service trolley of claim 1, wherein each ball caster assembly further comprises a collar attached to a bottom end of the caster housing of the ball caster assembly, wherein the collar retains the sphere wheel within the caster housing of the ball caster assembly.

4. The service trolley of claim 1, wherein each ball caster assembly further comprises a bearing housing and a bearing within the caster housing.

5. The service trolley of claim 1, wherein at least one ball caster assembly of the plurality of ball caster assemblies further comprises a braking system.

6. The service trolley of claim 5, wherein the braking system comprises a static brake pad within the caster housing and a dynamic brake pad configured to selectively clamp the sphere wheel.

7. The service trolley of claim 6, wherein the braking system further comprises a pedal connected to the dynamic brake pad using a wire, rod, or chain.

8. The service trolley of claim 1, wherein at least one ball caster assembly of the plurality of ball caster assemblies comprises a driven sphere wheel.

9. The service trolley of claim 1, wherein at least one ball caster assembly of the plurality of ball caster assemblies comprises a freely rotating sphere wheel.

10. The service trolley of claim 1, wherein the caster housing of at least one ball caster assembly comprises at least two fingers and a window between the at least two fingers.

11. The service trolley of claim 10, wherein the at least two fingers are configured to independently deflect outwards.

12. The service trolley of claim 10, wherein a first finger of the at least two fingers comprises a first length, and wherein a second finger of the at least two fingers comprises a second length that is less than the first length.

13. The service trolley of claim 12, wherein the second finger is arranged facing an aft direction of the trolley or a forward direction of the trolley.

14. The service trolley of claim 10, wherein the at least two fingers comprise at least three fingers, and wherein a lower portion of two of the at least three fingers are connected.

15. The service trolley of claim 10, further comprising a braking wedge within the housing and configured to selectively engage the sphere wheel.

16. A ball caster assembly for a service trolley for use onboard passenger transportation vehicles, the ball caster assembly comprising:
a housing comprising a plurality of fingers, wherein the plurality of fingers define a receiving area, and wherein the plurality of fingers comprise non-uniform lengths; and
a sphere ball retained within the receiving area of the housing.

17. The ball caster assembly of claim 16, wherein at least one finger of the plurality of fingers is configured to selectively deflect outwards.

18. The ball caster assembly of claim 16, further comprising a braking wedge within the receiving area and configured to selectively engage the sphere ball.

19. A service trolley for use onboard passenger transportation vehicles, the service trolley comprising:
a housing comprising an internal compartment, the housing comprising a top end and a bottom end; and
a ball caster assembly on the bottom end of the housing, the ball caster assembly comprising a caster housing and a sphere ball, wherein the caster housing comprises a plurality of fingers defining a receiving area, wherein at least one finger of the plurality of fingers is configured to selectively deflect outwards, and wherein the sphere ball is selectively retained within the receiving area.

20. The service trolley of claim 19, wherein at least one finger of the plurality of fingers comprises a length that is less than a length of another finger of the plurality of fingers.
